(19) United States
(12) Patent Application Publication
(10) Pub. No.: US 2018/0312437 A1
(43) Pub. Date: Nov. 1, 2018

(54) POLYURETHANE, MODIFIED ASPHALT AND MIXTURE MATERIAL CONTAINING SAME AND PAVEMENT STRUCTURE

(71) Applicants: RESEARCH INSTITUTE OF HIGHWAY MINISTRY OF TRANSPORT, Beijing (CN); BEIJING ZHONGLU GAOKE HIGHWAY TECHNOLOGY CO., LTD., Beijing (CN)

(72) Inventors: Dongwei CAO, Beijing (CN); Haiyan ZHANG, Beijing (CN); Yongjun FAN, Beijing (CN); Lei XIA, Beijing (CN); Yanjun ZHANG, Beijing (CN)

(21) Appl. No.: 15/739,662

(22) PCT Filed: Jun. 24, 2016
(86) PCT No.: PCT/CN2016/087102

§ 371 Date: Dec. 22, 2017

(30) Foreign Application Priority Data
Jun. 24, 2015 (CN) 201510353659.X
Jun. 25, 2015 (CN) 201510359604.X
Mar. 15, 2016 (CN) 201620198729.9

(51) Int. Cl. C04B 26/26; C04B 26/16; C04B 20/10; C08L 95/00; C08K 3/22; C08G 18/24; C08G 18/18

(52) U.S. Cl. CPC C04B 26/26; C04B 26/16; C04B 20/1044; C08G 18/48; C08K 3/22; C08G 18/242; C08G 18/18; C08L 95/00

(57) ABSTRACT

A polyurethane is obtained by continuously reacting a polyurethane prepolymer in an asphalt or asphalt mixture material system under high temperature. The prepolymer is prepared by: adding a polymerization inhibitor, catalyst and isocyanate component in a reaction container, adding a polyol to the reactor while stirring at room temperature under nitrogen, increasing the temperature to 50-80° C., and maintaining the temperature to react for 0.5-6 hours. A polyurethane modified asphalt, a mixture material containing the polyurethane and a polyurethane modified asphalt pavement structure can be prepared. The synthesis condition of the polyurethane is mild, and a secondary reaction with the air and an active hydrogen component in the asphalt can occur during maintenance and formation to further increase the strength of a mixture material. The standard Marshall stability at 60° C. meets the petroleum asphalt requirement, such that a service life of the asphalt pavement can be increased.

### TECHNICAL FIELD

The present invention relates to the field of road engineering, particularly, to a polyurethane and preparation method and application thereof.

### BACKGROUND ART

Polyurethane is a kind of organic polymer formed of soft and hard segments embedded therein. The difference in polarities between hard and soft segments and the crystallinity of hard segments themselves lead to incompatiblity of soft and hard segments, which may result in SBS-like two-phase-separated structure. After polyurethane is cured, the hard segments provide certain strength for the material, meanwhile the soft segments provide the material with corresponding flexibility. Polyurethane can be used in the asphalt system to improve the high-temperature and low-temperature performance of the matrix asphalt.

Chinese patent CN102617070A discloses a polyurethane asphalt concrete and preparation method and application thereof, wherein the polyurethane prepolymer is prepared from an isocyanate, a polyol compound, a catalyst, and a plasticizer as raw materials by reaction, and the polyurethane asphalt concrete mixture material prepared from the polyurethane prepolymer and diluted asphalt by cold stirring and cold paving has excellent performance. However, the raw materials for the synthesis of the polyurethane prepolymer are all non-renewable petroleum resources; the catalyst, the plasticizer and other additives must be contained; and the synthesis temperature is up to 80-90° C.

Chinese patent CN103232717A discloses a polyurethane epoxy composite modified asphalt and preparation method thereof. The composite modified asphalt product is prepared from a polyol, a catalyst and an epoxy resin by reaction at a high temperature; then allowing to react with an isocyanate component to give the semi-finished product of polyurethane modified epoxy resin; then adding solubilizer, plasticizer, curing agent and other additives to give the polyurethane epoxy composite modified asphalt product. The Marshall stability at 60° C. of the composite modified asphalt concrete meets the requirement of the EA-10 specification for epoxy asphalt concrete, but the additives are complex, and the high strength of the mixture material mostly depends on the large rigidity and high strength of the epoxy asphalt.

At present, due to severe diseases caused by heavy vehicles, the phenomenon of rutting occurs frequently to the existing roads that have not yet reached the design life, increasing the number of maintenance within the service life and life cycle cost, and load cracks and temperature cracks can easily induce and produce destructive damage under the catalyzation of driving load, thereby resulting in temperature cracks and fatigue cracks on the pavement. Polyurethane can be used to improve the rutting resistance, low temperature crack resistance and fatigue resistance of existing pavement structures, and can significantly improve the durability of the pavement.

### SUMMARY OF THE INVENTION

In view of the deficiencies of the prior art, one of the objectives of the present invention is to provide a polyurethane.

Another object of the present invention is to provide a method for preparing the polyurethane.

A third object of the present invention is to provide a modified asphalt containing the polyurethane.

A fourth object of the present invention is to provide an asphalt mixture material containing the polyurethane.

The fifth object of the present invention is to provide a pavement structure containing the polyurethane asphalt mixture material.

The technical solutions for achieving the above object of the present invention are provided as follows:

A polyurethane, the polyurethane is obtained by continuously reacting the polyurethane prepolymer in a asphalt or asphalt mixture material system under high temperature, and the polyurethane prepolymer is prepared by the following method:

polymerization inhibitor, catalyst and isocyanate component are added into a reactor, polyol is added to the reactor while stirring at room temperature under nitrogen, and the resulting mixture is heated to 50-80° C., and held the temperature to react for 0.5 to 6 hours;

wherein, the polymerization inhibitor is one or two selected from the group consisting of p-benzenesulfonate, benzoyl chloride, phosphoric acid and dimethyl sulfate; the isocyanate component is one or two selected from the group consisting of liquefied MDI, TDI dimer, TDI trimer, TDI-TMP adduct, HDI dimer, HDI trimer, and IPDI trimer; the polyol is one or more selected from the group consisting of castor oil, dehydrated castor oil, adipic acid-based polyester diol, polyolefin polyol, polyoxypropylene glycol (PPG), polyoxypropylene-oxyethylene copolyether triol, trimethylolpropane (TMP), vegetable oil polyol and polytetrahydrofuran polyol.

Specifically, in the method for preparing the polyurethane prepolymer, the molar ratio R (isocyanate index) between the —NCO group in the isocyanate component and the —OH group in the polyol component is preferably 1.4 to 2.0, and based on the total mass of the isocyanate component and the polyol, 0.01% to 3% of polymerization inhibitor is added.

Wherein in the method for preparing the polyurethane prepolymer, based on the total mass of the isocyanate component and the polyol, 0.5% to 1% of catalyst is added, and the catalyst is one of an organotin-based catalyst, a tertiary amine-based catalyst and a quaternary ammonium salt compound.

Wherein the polyol is one of polyester polyols, polyether polyols and vegetable oil polyols, or a composite polyol of any two of them; the polyester polyol is one of adipic acid-based polyester diols, polyolefin polyols and polyoxypropylene glycol (PPG); and the polyether polyols is one or more selected from the group consisting of polyoxypropylene-oxyethylene copolyether triol, trimethylolpropane (TMP), vegetable oil polyol and polytetrahydrofuran polyol.

More preferably, the mass ratio of the polyester polyol to the polyether polyol in the composite polyol is (2:1) to (1:1); in the preparation method, the polyester polyol is added first to the reactor, heated to 50-80° C., and held at the temperature for 0.5 to 1.5 hours, then the polyether polyol is dropwise added to the reaction system, and the resulting mixture is held at the temperature to react for 1.5 to 3 hours.

In the technical solution, polyether polyol with good flexibility is connected in the molecule so that the synthesized macromolecules have good flexibility, and the modified asphalt has good low-temperature flexibility; in the technical solution adopting composite polyol, the later dropwise added substance generally has a relatively small molecular weight, so as to make the reaction continued. R value is the total molar ratio of two groups, and the molar mass is converted according to the respective mass.

Wherein the polyol is obtained by dehydrating in a vacuum box at 110-120° C. under a pressure of 0.05 to 0.2 MPa for 2 to 3 hours; in the preparation method, the reactor is added with 10% to 50%, based on the total mass of the reactant, of a solvent which is one or two of acetone, ethyl acetate and butyl acetate.

In the method for preparing polyurethane, after the reaction is conducted at 50-80° C. for 0.5 to 6 hours, the obtained reaction system (which can be called as prepolymer) is component A, and other additives are component B; and the other additives are obtained from 1 part (by mass, the same below) of catalyst, 3 parts of chain extender, 1 part of plasticizer and 1 part of anti-foaming agent; the components A and B are stirred and mixed in a mass ratio of 1:0.8-1.2 for use.

Wherein the catalyst is one of an organotin-based catalyst and a tertiary amine-based catalyst; the chain extender is one of trimethylolpropane, 1,4-butanediol, 1,2-propanediol, polyethylene glycol 200, triethanolamine and other small molecule alcohols and amines; the plasticizer is one of dioctyl phthalate, dibutyl phthalate; and the anti-foaming agent is calcium oxide.

The present invention also provides a polyurethane modified asphalt, wherein the polyurethane modified asphalt comprises the polyurethane prepolymer provided by the present invention and a matrix asphalt, and the polyurethane prepolymer accounts for 10% to 40% by weight of the modified asphalt.

The polyurethane modified asphalt is prepared by the following method:

the polyurethane prepolymer is mixed with the matrix asphalt, quickly stirred at 120-130° C. for 10 to 30 min, and the polyurethane prepolymer continues to react in the asphalt system to obtain polyurethane modified asphalt.

The polyurethane modified asphalt is composed of 10-40 parts of polyurethane prepolymer, 90-50 parts of asphalt and 0-5 parts of other additive; and the other additive is one or more of a catalyst, a chain extender, a plasticizer and an anti-foaming agent.

Wherein the catalyst is one of an organotin-based catalyst and a tertiary amine catalyst, accounting for 1% to 3% of the total amount of the polyurethane;

The chain extender is one of trimethylolpropane, 1,4-butanediol, 1,2-propanediol, polyethylene glycol 200, triethanolamine and other small molecule alcohols and amines, accounting for 2% to 4% of the total amount of the vegetable oil-based polyurethane.

The plasticizer is one of dioctyl phthalate and dibutyl phthalate, accounting for 2% to 5% of the total amount of the vegetable oil-based polyurethane; the anti-foaming agent is calcium oxide, accounting for 0 to 1% of the total amount of vegetable oil-based polyurethane.

Furthermore, the polyurethane modified asphalt is prepared by the following method:

the matrix asphalt is baked at 135° C. for 3 hours and then slowly added with the polyurethane prepolymer at 110-120° C. while shearing.

A mixture material contains the polyurethane of the present invention.

The mixture material is prepared by one of the following methods:

method I: the aggregates are baked at a temperature of 120-130° C. for 3 to 6 hours, 100 parts of the baked aggregates are added to a mixing pot at 110-150° C., 2-8 parts of polyurethane modified asphalt is added thereto, mixed well at 110-150° C., then added with ore powder, and mixed for 80 to 50 s;

method II: 100 parts of aggregates are pre-heated at 130-165° C., the fine aggregates and coarse aggregates are added to a mixing pot heated to 130-165° C. and mixed well; 4-6 parts of the vegetable oil-based polyurethane of the present invention, other additive and asphalt are added to the aggregates, and mixed for 90 to 180 s; the ore powder is added to the mixed material, continuously mixed well for 90 to 180 s, and then compaction molded at 135-140° C.; and the molded specimen is cured in an oven at 100° C. for 20 to 30 hours, and then cured at room temperature for 2 to 4 days;

method III: the aggregates are preheated at 140-170° C., the fine aggregates and the coarse aggregates are added to a mixing pot heated to 140-170° C., and mixed well; the castor oil-based polyurethane modified asphalt of the present invention is added to the aggregate, and mixed for 90 to 180 s; the ore powder is added to the mixed material, continuously mixed well for 90 to 180 s, and then compacted for 70 to 80 times to compaction mold at 135-140° C.; and the molded specimen is cured in an oven at 100° C. for 24 hours, and then cured at room temperature for 2 to 4 days.

Wherein the fine aggregates have a nominal grain size of 0.075 mm<δ<4.75 mm, the coarse aggregates have a nominal grain size of 4.75 mm≤δ, the ore powder is obtained from limestone by grinding, and has a nominal grain size of δ≤0.075 mm; the gradation of the aggregates meets the Technical Specification for Construction of Highway Asphalt Pavements.

The other additive is one or more of a catalyst, a chain extender, a plasticizer and an anti-foaming agent, the catalyst is one of an organotin-based catalyst and a tertiary amine catalyst, accounting for 1% to 3% of the total amount of the polyurethane prepolymer; the chain extender is one of trimethylolpropane (TMP), 1,4-butanediol, 1,2-propanediol, polyethylene glycol 200, triethanolamine and other small molecule alcohols and amines, accounting for 2% to 4% of the total amount of the vegetable oil-based polyurethane prepolymer; the plasticizer is one of dioctyl phthalate, dibutyl phthalate, accounting for 2% to 5% of the total amount of the vegetable oil-based polyurethane prepolymer; and the anti-foaming agent is calcium oxide, accounting for 0 to 1% of the total amount of the vegetable oil-based polyurethane prepolymer.

The mixture material of the present invention can be used for paving, reinforcing and repairing ordinary highways, expressways, municipal roads, pavements for very heavy traffic, hot area pavements, square pavements and airport pavements.

A pavement structure using polyurethane modified asphalt comprises: a roadbed, a base layer and a surface layer sequentially arranged from bottom to top, wherein the surface layer is made of the mixture material of the present invention; and the layer number of the surface layer is at least one.

Furthermore, the layer number of the surface layers is two or more, an adhesive layer is provided between every two surface layers, and the adhesive layer is made of emulsified asphalt or modified emulsified asphalt or modified asphalt or petroleum asphalt or other adhesive materials meeting the Technical Specification for Construction of Highway Asphalt Pavements, and the spreading amount of the adhesive layer is 0.3 L/m² to 2.5 L/m².

Wherein layer-penetration oil is sprayed between the base layer and the surface layer.

Wherein a sealing layer is provided between the layer-penetration oil and the surface layer.

Wherein the base layer is a flexible base layer or a semi-rigid base layer or a rigid base layer.

The present invention has the following beneficial effects:

The polyurethane provided by the invention is synthesized under mild conditions, and can occur secondary reaction with air and active hydrogen components in asphalt during the curing process to further enhance the strength of the mixture, and the standard Marshall stability at 60° C. of the polyurethane-modified asphalt meets the requirements of petroleum asphalt specification, and can prolong the service life of asphalt pavement.

The modified asphalt mixture using the polyurethane of the present invention has low mixing temperature, and short curing time; Marshall strength of the mixture material in a short period of time is high at a relatively low dosage, and the intensity increases with the increase of temperature and the extension of curing time.

The surface layer of the polyurethane modified asphalt pavement structure provided by the invention is made of polyurethane modified asphalt mixture material, which has the advantages of fatigue resistance, high hardness, good elasticity, strong abrasion resistance and the like, can effectively improve the rutting resistance, low temperature resistance, and water and crack resistance of the pavement, thereby avoiding pavement cracking, playing the role of protecting pavement, prolonging the service life of the road, and improving safety of the pavement. In addition, the polyurethane modified asphalt pavement structure has low post-maintenance cost, which is conducive to economy.

### BRIEF DESCRIPTION OF THE DRAWINGS

FIG. 1 is an infrared spectrum of the polyurethane modifier prepared according to Example 3 of the present invention.

FIG. 2 is infrared spectrum of polyurethane modified asphalts with different dosages.

FIG. 3 is a structural schematic diagram of the polyurethane modified asphalt pavement structure according to Example 20 of the present invention.

In the figures: 1: an upper surface layer; 2: a first adhesive layer 3: a middle surface layer 4: a second adhesive layer 5: a lower surface layer.

### SPECIFIC MODES FOR CARRYING OUT THE EMBODIMENTS

The present invention is illustrated by the following preferred examples, but the examples are not intended to limit the scope of the present invention.

In the examples, the softening point and ductility of the modified asphalt were tested according to the national standards GB/T4507-1999 and GB/T4508-1999.

Dehydrated castor oil in the examples was prepared as follows: Castor oil (Sinopharm, AR, hydroxyl value of 164 mgKOH/g) was dehydrated in a vacuum oven at 110° C. under 0.1 MPa. for 2 h, and cooled.

### Example 1

Preparation of polyurethane prepolymer: based on the total mass of the reactants, 0.5% of phosphoric acid as a polymerization inhibitor, acetone as a solvent, and 0.5% of dibutyltin dilaurate as a catalyst were added to a reactor, stirred well, and then added with liquefied MDI as an isocyanate component, and adipic acid-based polyester diol was added to the reactor while stirring at room temperature under nitrogen with the R of 1.6 (two polyols are calculated together), then the mixture was heated to 50° C., and held the temperature to react for 2 hours.

Afterward, a second polyol (trimethylolpropane) (TMP) was dropwise added to the reaction system through a constant pressure separating funnel to conduct chain extension (the mass ratio of the second polyol to the first polyol was 2:1), and held the temperature to react for 2 hours; then the reaction system was cooled to room temperature, nitrogen introduction was stopped, the reaction was stopped, and the product was discharged.

After curing at 130° C., a polyurethane specimen bar was prepared.

Preparation of polyurethane modified asphalt: matrix asphalt was baked and stirred with the synthesized polyurethane prepolymer at 120° C. for 10 minutes to give polyurethane modified asphalt, in which the polyurethane prepolymer accounts for 20% of the modified asphalt thereof.

Preparation of the modified asphalt mixture material: AC-20 graded aggregates were baked in an oven at 120° C. for 5 hours, 100 parts of the baked AC-20 graded aggregates were added to a mixing pot at 120° C., then 4.3 parts of the polyurethane modified asphalt prepared above was added to the mixing pot, and mixed well at 120° C. for 90 s, subsequently, ore powder was added and stirred for 90 s.

Molded specimens were cured in an oven at 150° C.

The aggregates in this example are composed of 21.1% by mass of fine aggregates and 73.8% by mass of coarse aggregates and 5.1% by mass of ore powder. Wherein, the nominal grain size of the fine aggregates is 0.075 mm<δ<2.36 mm, the nominal grain size of the coarse aggregates is 2.36 mm≤δ, the nominal grain size of the ore powder is δ≤0.075 mm, and both the fine aggregates and the coarse aggregates are limestone.

Property Characterization

Conventional Marshall property test was performed on the mixture material specimens of the example according to Standard Test Methods of Bitumen and Bituminous Mixtures for Highway Engineering (JTG E20-2011), and the tensile strength and elongation at break of the polyurethane specimen bars were tested according to Plastics-Determination of tensile properties GBT 1040-2006. The test results were shown in Table 1 and Table 2.

TABLE 1
Mechanical properties of the specimen bar of Example 1

| | Tensile | Elongation at |
|---|---|---|
| Example | strength/Mpa | break/% |
| Example 1 | 8.78 | 93.23 |

TABLE 2
Conventional Marshall property test on the mixture material specimen of Example 1

| | Curing for 2 h | | Curing for 5 h | | Curing for 1 d | | Curing for 3 d | | Curing for 5 d | |
|---|---|---|---|---|---|---|---|---|---|---|
| | | Flow | | Flow | | Flow | | Flow | | Flow |
| Example | Stability | value | Stability | value | Stability | value | Stability | value | Stability | value |
| Example 1 | 13.11 | 3.02 | 21.81 | 3.11 | 23.26 | 3.08 | 29.88 | 2.65 | 49.32 | 2.69 |

### Example 2

Vegetable oil-based polyurethane modified asphalt was prepared as follows:

1) Synthesis of vegetable oil-based polyurethane prepolymer: based on the total mass of castor oil and liquefied MDI, 0.1% of orthophosphoric acid as a polymerization inhibitor was added to a dry four-necked flask at room temperature under nitrogen, then liquefied MDI was added according to isocyanate index R=1.6, and stirred for 5 minutes, subsequently corresponding amount of dehydrated castor oil was dropwise added to the four-necked flask through a dropping funnel with controlled stirring speed and dropping speed. During the reaction process, depending on the variation of the viscosity of the reaction system, solvent acetone was added for viscosity adjustment to allow for continuous reaction, a total of 35% (based on the total amount of the reactants) of solvent acetone was added for viscosity adjustment. After addition of castor oil was finished, the reaction was continued for 50 min to obtain polyurethane prepolymer with terminal NCO group.

2) Preparation of modified asphalt

2 parts of tin-based catalyst dibutyltin dilaurate was added to 70 parts of asphalt, and then 30 parts of the vegetable oil-based polyurethane prepolymer synthesized in step 1) was slowly added to the 70 parts of matrix asphalt with the tin-based catalyst at 115° C. while shearing, and sheared well for 70 min to give vegetable oil-based polyurethane modified asphalt.

### Example 3

Vegetable oil-based polyurethane modified asphalt was prepared as follows:

1) Synthesis of vegetable oil-based polyurethane prepolymer: based on the total mass of castor oil and liquefied MDI, 0.1% of orthophosphoric acid as a polymerization inhibitor was added to a dry four-necked flask at room temperature under nitrogen, then liquefied MDI was added according to isocyanate index R=1.8, and stirred for 5 minutes, subsequently corresponding amount of dehydrated castor oil was dropwise added to the four-necked flask through a dropping funnel with controlled stirring speed and dropping speed. During the reaction process, depending on the variation of the viscosity of the reaction system, solvent acetone was added for viscosity adjustment to allow for continuous reaction, a total of 40% (based on the total amount of the reactants) of solvent acetone was added for viscosity adjustment. After addition of castor oil was finished, the reaction was continued for 50 min to obtain polyurethane prepolymer with terminal NCO group.

2) Preparation of modified asphalt

2 parts of tin-based catalyst dibutyltin dilaurate was added to 60 parts of matrix asphalt, and then 40 parts of the vegetable oil-based polyurethane prepolymer synthesized in step 1) was slowly added to the 60 parts of matrix asphalt with the catalyst at 115° C. while shearing, and sheared well for 90 min to give vegetable oil-based polyurethane modified asphalt.

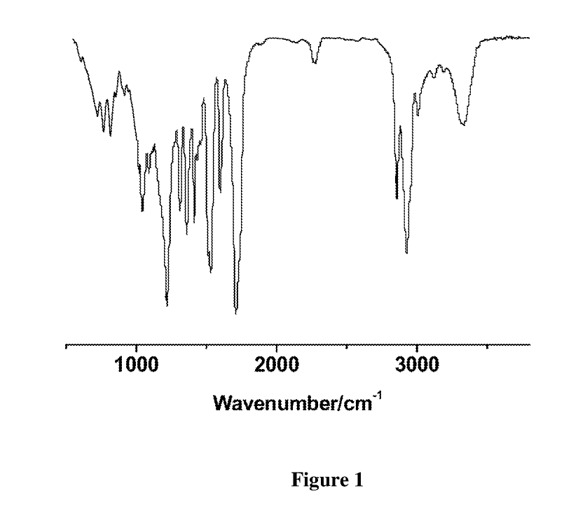

Infrared spectrum of polyurethane prepolymer modifier was shown in FIG. 1, in which the vertical axis was the light transmittance. The absorption peak around the wave number 3334 cm⁻¹ was a stretching vibration peak of N—H, and the absorption peak at 1710 cm⁻¹ was the combined characteristic absorption peak of urethane (NH—CO—O) and the carbonyl group (—CO—O) on the long carbon chain of castor oil, the absorption peak at 2275 cm⁻¹ was the antisymmetric stretching characteristic peak of the —NCO group in isocyanate, and the absorption peak at 1310-1360 cm⁻¹ was the symmetrical stretching peak of the —NCO group in isocyanate. It can be seen that, urethane chain segment was generated in the product, and the synthesized product was polyurethane prepolymer terminated with excessive —NCO. In FIG. 1, the absorption peak at 1450-1650 cm⁻¹ was the five-finger absorption peak for the benzene ring. This figure was infrared absorption peak spectrum of the synthesized vegetable oil-based polyurethane modifier.

### Example 4

Vegetable oil-based polyurethane modified asphalt was prepared as follows:

1) Synthesis of vegetable oil-based polyurethane prepolymer: based on the total mass of castor oil and liquefied MDI, 0.1% of orthophosphoric acid as a polymerization inhibitor was added to a dry four-necked flask at room temperature under nitrogen, then liquefied MDI was added according to isocyanate index R=1.6, and stirred for 5 minutes, subsequently corresponding amount of dehydrated castor oil was dropwise added to the four-necked flask through a dropping funnel with controlled stirring speed and dropping speed. During the reaction process, depending on the variation of the viscosity of the reaction system, solvent acetone was added for viscosity adjustment to allow for continuous reaction, a total of 35% (based on the total amount of the reactants) of solvent acetone was added for viscosity adjustment. After addition of castor oil was finished, the reaction was continued for 50 min to obtain polyurethane prepolymer with terminal NCO group.

2) Preparation of modified asphalt

2 parts of tin-based catalyst dibutyltin dilaurate was added to 90 parts of matrix asphalt, and then 10 parts of the vegetable oil-based polyurethane prepolymer synthesized in step 1) was slowly added to the 90 parts of matrix asphalt with the tin-based catalyst at 115° C. while shearing, and sheared well for 40 min to give vegetable oil-based polyurethane modified asphalt.

### Example 5

Vegetable oil-based polyurethane modified asphalt was prepared as follows:

1) Synthesis of vegetable oil-based polyurethane prepolymer: based on the total mass of castor oil and liquefied MDI, 0.5% of orthophosphoric acid as a polymerization inhibitor was added to a dry four-necked flask at room temperature under nitrogen, then liquefied MDI was added according to isocyanate index R=2.0, and stirred for 5 minutes, subsequently corresponding amount of dehydrated castor oil was dropwise added to the four-necked flask through a dropping funnel with controlled stirring speed and dropping speed. During the reaction process, depending on the variation of the viscosity of the reaction system, solvent acetone was added for viscosity adjustment to allow for continuous reaction, a total of 40% (based on the total amount of the reactants) of solvent acetone was added for viscosity adjustment. After addition of castor oil was finished, 3.0% (based on the total mass of the system) of chain extender trimethylolpropane (TMP) was dropwise added slowly to the four-neck flask. After the addition was finished, the reaction was continued for 10 min to give polyurethane prepolymer with terminal NCO group.

2) Preparation of modified asphalt

Based on the total amount of the prepolymer, 1.0% of dibutyltin dilaurate, 3.0% of plasticizer dioctyl phthalate, and 0.5% of anti-foaming agent calcium oxide (CaO) were sequentially added to 90 parts of matrix asphalt, and stirred well. Then 10 parts of the vegetable oil-based polyurethane prepolymer synthesized in step 1) and having chain extended by trimethylolpropane was slowly added to the 90 parts of asphalt with other additives at 120° C. while shearing, and sheared well for 60 min to give vegetable oil-based polyurethane modified asphalt.

### Example 6

1) The method for synthesizing the vegetable oil-based polyurethane prepolymer was the same as Example 4.

2) Preparation of modified asphalt

Based on the total amount of the prepolymer, 1.0% of catalyst dibutyltin dilaurate was added to 80 parts of matrix asphalt, and stirred well. Then 20 parts of the vegetable oil-based polyurethane prepolymer synthesized in step 1) was slowly added to the 80 parts of asphalt at 120° C. while shearing, and sheared well for 60 min to give vegetable oil-based polyurethane modified asphalt.

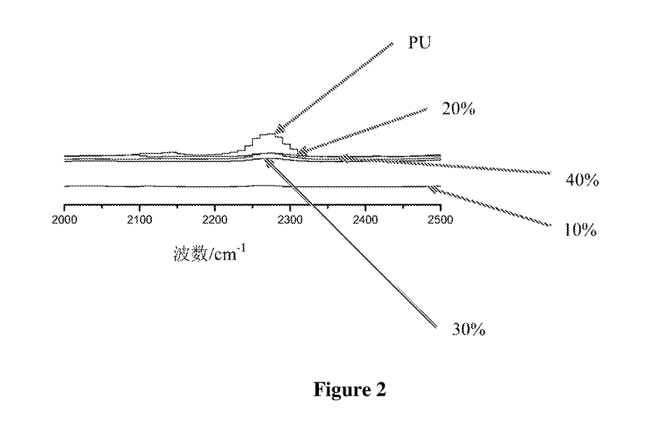

FIG. 2 was a comparative infrared spectrum of the polyurethane prepolymer after and before addition of a modifier to asphalt in Examples 2-6. In this figure, the characteristic absorption peak of the characteristic functional group of isocyanate, —NCO, present at about 2275 cm⁻¹ showd a series of changes in intensity. The —NCO peak was obvious in the polyurethane prepolymer, which further proved that —NCO is excessive in the system and the synthesized prepolymer is terminated with —NCO. After the polyurethane prepolymer was added into the matrix asphalt, the intensity of the characteristic absorption peak of the characteristic functional group of isocyanate, —NCO, present at about 2275 cm⁻¹ decreased significantly until it is 0, indicating that the polyurethane prepolymer can react with the active hydrogen compound in the asphalt system continuously, the simple physical blending modification was gradually transformed into chemical modification, which further improved the asphalt performance. This is also the reason why the strength of the mixture material is improved to a certain extent relative to the matrix asphalt. The change in the intensity of the absorption peak shown in the figure can explain the modification mechanism between the modifier and the asphalt, and further explain the intensity increase of the mixture from the aspect of chemical reaction. In FIG. 2, from the top to the bottom, the top line is PU, the second line is 20%, the third line is 40%, the fourth line is 30%, and the fifth line is 10%, wherein the peak values of the second and third lines almost overlap with each other.

### Example 7 Preparation of the Mixture Material

100 parts of AC-13 graded aggregates were added to a mixing pot at 165° C. and mixed well, then 4.8 parts of the vegetable oil-based polyurethane modified asphalt prepared in Example 2 was added and stirred well (stirring time: 90 s). Ore powder was added to the resulting mixture material, and stirred well for 90 s. The resulting mixture material was compaction molded at 135° C. for 75 times (the compaction equipment is fully-automatic mixture compaction device, model: LD139). The molded specimens were cured in an oven at 100° C. for 24 h, and cured at room temperature for 2 days. The specimens were tested to have a Marshall stability at 60° C. of 11.01 and a flow value of 3.71.

The aggregates in this example satisfied the Technical Specification for Construction of Highway Asphalt Pavements, wherein the fine aggregates were limestone, and had a nominal grain size of 0.075 mm<δ<4.75 mm; the coarse aggregates were basalt, and had a nominal grain size of 4.75 mm≤δ; the ore powder was prepared from high-quality limestone by grinding, and had a nominal grain size of δ≤0.075 mm; and the gradation of the aggregates was an AC-type gradation that meets the Technical Specification for Construction of Highway Asphalt Pavements.

### Example 8 Preparation of the Mixture

100 parts of AC-13 graded aggregates were added to a mixing pot at 165° C. and mixed well, then 4.8 parts of the vegetable oil-based polyurethane modified asphalt prepared in Example 3 was added and stirred well (stirring time: 90 s). Ore powder was added to the resulting mixture material, and stirred well for 90 s. The resulting mixture material was compaction molded at 135° C. for 75 times (the compaction equipment is fully-automatic mixture compaction device, model: LD139). The molded specimens were cured in an oven at 100° C. for 24 h, and cured at room temperature for 3 days. The specimens were tested to have a Marshall stability at 60° C. of 12.51 and a flow value of 3.43.

The composition of the aggregates was the same as that in Example 7.

### Example 9 Preparation of a Mixture

100 parts of AC-13 graded aggregates were added to a mixing pot at 165° C. and mixed well, then 4.8 parts of the vegetable oil-based polyurethane modified asphalt prepared in Example 4 was added and stirred well (stirring time: 90 s). Ore powder was added to the resulting mixture material, and stirred well for 90 s. The resulting mixture material was compaction molded at 135° C. for 75 times (the compaction equipment is fully-automatic mixture compaction device, model: LD139). The molded specimens were cured in an oven at 100° C. for 24 h, and cured at room temperature for 4 days. The specimens were tested to have a Marshall stability at 60° C. of 10.53 and a flow value of 3.42.

The composition of the aggregates was the same as that in Example 7.

### Example 10 Preparation of a Mixture

100 parts of AC-13 graded aggregates were added to a mixing pot at 165° C. and mixed well, then 4.8 parts of the vegetable oil-based polyurethane modified asphalt prepared in Example 5 was added and stirred well (stirring time: 90 s). Ore powder was added to the resulting mixture material, and stirred well for 90 s. The resulting mixture material was compaction molded at 135° C. for 75 times (the compaction equipment is fully-automatic mixture compaction device, model: LD139). The molded specimens were cured in an oven at 100° C. for 24 h, and cured at room temperature for 2 days. The specimens were tested to have a Marshall stability at 60° C. of 11.0 and a flow value of 3.02.

The composition of the aggregates was the same as that in Example 7.

### Example 11 Preparation of Mixture

100 parts of AC-13 graded aggregates were added to a mixing pot at 165° C. and mixed well, then 4.8 parts of the vegetable oil-based polyurethane modified asphalt prepared in Example 6 was added and stirred well (stirring time: 90 s). Ore powder was added to the resulting mixture material, and stirred well for 90 s. The resulting mixture material was compaction molded at 135° C. for 80 times (the compaction equipment is fully-automatic mixture compaction device, model: LD139). The molded specimens were cured in an oven at 100° C. for 24 h, and cured at room temperature for 2 days. The specimens were tested to have a Marshall stability at 60° C. of 10.23 and a flow value of 3.58.

The composition of the aggregates was the same as that in Example 7.

### Example 12

According to the preparation method of the vegetable oil-based polyurethane prepolymer in Example 3, the vegetable oil-based polyurethane prepolymer was prepared with the isocyanate index R of 2.0 to serve as the component A. 4.0% of the chain extender TMP based on the total amount of the prepolymer was dissolved in absolute ethanol at a mass ratio of 1:3. 4.0% of plasticizer dioctyl phthalate, 1.0% of catalyst dibutyltin dilaurate, and 1.0% of calcium oxide (CaO) were taken as the component B. Matrix asphalt was taken as component C. Components A and B were mixed well, and then mixed with component C at a ratio of 1:1 to give a mixture material.

100 parts of AC-13 graded aggregates were added to a mixing pot at 165° C. and mixed well, then 4.8 parts of the mixture of the above components A, B and C was added and stirred well (stirring time: 90 s). Ore powder was added to the resulting mixture material, and stirred well for 90 s. The resulting mixture material was compaction molded at 135° C. for 75 times (the compaction equipment is fully-automatic mixture compaction device, model: LD139). The molded specimens were cured in an oven at 100° C. for 24 h, and cured at room temperature for 2 days. The specimens were tested to have a Marshall stability at 60° C. of 11.5 and a flow value of 3.15.

### Property Characterization of Examples 7-12

Conventional Marshall property test was performed on the modified asphalt mixture material prepared from the vegetable oil-based polyurethane of the Examples 2-6 according to Standard Test Methods of Bitumen and Bituminous Mixtures for Highway Engineering (JTG E20-2011).

TABLE 3
Test on Marshall property of the vegetable oil-based
polyurethane modified asphalt mixture material

| | | Flow |
|---|---|---|
| Example | Marshall stability(KN) | value(mm) |
| Example 7 | 11.01 | 3.71 |
| Example 8 | 12.51 | 3.43 |
| Example 9 | 10.53 | 3.42 |
| Example 10 | 11.0 | 3.02 |
| Example 11 | 10.23 | 3.58 |
| Example 12 | 11.5 | 3.15 |
| Requirements of | Expressway and first-class | — |
| specification for petroleum | highway ≥8, other classes | |
| asphalt | highways: 5 | |

### Example 13

Castor oil-based polyurethane modified asphalt was prepared as follows:

1) Preparation of oil-containing asphalt: the matrix asphalt was baked at 135° C. for 3 hours, and the castor oil was added slowly to the matrix asphalt while shearing at 110° C. for 40 minutes.

2) Preparation of modified asphalt: 1% of the polymerization inhibitor phosphoric acid was added to the oil-containing asphalt system to control the polymerization reaction of the asphalt system, and two monomers were added in an amount of 10% calculated according to internal mixing method with the following formula:

Sum of two monomers/(sum of two monomers+matrix asphalt)=10%

The isocyanate index R of the contents of the two monomers was 1.6. The corresponding amount of liquefied MDI was dropwise added into the reactor through a dropping funnel at a temperature of 115° C. with a dropping rate controlled at 10 drops/min, and then fully sheared for 20 minutes after dropping was finished to make the reaction system dispersed uniformly and stably. The test results on the three indicators of the resulting modified asphalt were as follows: ductility at 5° C. being 5.4 cm, softening point at 5° C. being 53° C., and needle penetration at 25° C. being 69 mm.

### Example 14

Castor oil-based polyurethane modified asphalt was prepared as follows:

1) Preparation of oil-containing asphalt: the matrix asphalt was baked at 135° C. for 3 hours, and the castor oil was added slowly to the matrix asphalt while shearing at 110° C. for 60 minutes.

2) Preparation of modified asphalt: 2% of the polymerization inhibitor p-toluenesulfonate was added to the oil-containing asphalt system to control the polymerization reaction of the asphalt system, and two monomers were added in an amount of 20% calculated according to the internal mixing method. The isocyanate index R of the contents of the two monomers was 1.8. The corresponding amount of liquefied MDI was dropwise added into the reactor through a dropping funnel at a temperature of 120° C. with a dropping rate controlled at 12 drops/min, and then fully sheared for 40 minutes after dropping was finished to make the reaction system dispersed uniformly and stably. The test results on the three major indicators of the resulting modified asphalt were as follows: ductility at 5° C. being 12.2 cm, softening point at 5° C. being 49.6° C., and needle penetration at 25° C. being 88 mm.

### Example 15

Step 1) of the preparation of the Castor oil-based polyurethane modified asphalt was the same as that of Example 2.

2) Preparation of modified asphalt: 2% of the polymerization inhibitor phosphoric acid was added to the oil-containing asphalt system to control the polymerization reaction of the asphalt system, and two monomers were added in an amount of 25% calculated according to the internal mixing method. The isocyanate index R of the contents of the two monomers was 1.6. The corresponding amount of liquefied MDI was dropwise added into the reactor through a dropping funnel at a temperature of 120° C. with a dropping rate controlled at 12 drops/min, and then fully sheared for 30 minutes after dropping was finished to make the reaction system dispersed uniformly and stably. The test results on the three major indicators of the resulting modified asphalt were as follows: ductility at 5° C. being 11.8 cm, softening point at 5° C. being 50° C., and needle penetration at 25° C. being 84 mm. The modified asphalt has similar properties to that of Example 2.

### Example 16

Castor oil-based polyurethane modified asphalt was prepared as follows:

1) Preparation of oil-containing asphalt: the matrix asphalt was baked at 135° C. for 3 hours, and the castor oil was added slowly to the matrix asphalt while shearing at 120° C. for 90 minutes.

2) Preparation of modified asphalt: 3% of the polymerization inhibitor was added to the oil-containing asphalt system to control the polymerization reaction of the asphalt system, and two monomers were added in an amount of 30% calculated according to the internal mixing method. The isocyanate index R of the contents of the two monomers was 1.8. The corresponding amount of liquefied MDI was dropwise added into the reactor through a dropping funnel at a temperature of 140° C. with a dropping rate controlled at 15 drops/min, and then fully sheared for 50 minutes after dropping was finished to make the reaction system dispersed uniformly and stably. The test results on the three major indicators of the resulting modified asphalt were as follows: ductility at 5° C. being 4.8 cm, softening point at 5° C. being 57.6° C., and needle penetration at 25° C. being 64 mm.

TABLE 4
Test on three major indicators of castor
oil-based polyurethane modified asphalt

| | | | needle |
|---|---|---|---|
| | softening point | ductility | penetration |
| Example | at 5° C./° C. | at 5° C./cm | at 25° C./mm |
| Example 13 | 53.0 | 5.4 | 69 |
| Example 14 | 49.6 | 12.2 | 88 |
| Example 15 | 50.0 | 11.8 | 84 |
| Example 16 | 57.6 | 4.8 | 64 |

### Example 17 Preparation of Modified Asphalt Mixture

The aggregates used in the examples were as follows: based on the total mass of the fine aggregates, the coarse aggregates and ore powder, fine aggregates account for 50%, coarse aggregates account for 45%, and ore powder accounts for 5%, wherein the fine aggregates were limestone, and had a nominal grain size of 0.075 mm<δ<4.75 mm; the coarse aggregates were basalt, and had a nominal grain size of 4.75 mm≤δ; the ore powder was prepared from high-quality limestone by grinding, and had a nominal grain size of δ≤0.075 mm. The gradation of aggregates meets the Technical Specification for Construction of Highway Asphalt Pavements.

100 parts of AC-13 graded aggregates were added to a mixing pot at 170° C. and mixed well, then 4.8 parts of the vegetable oil-based polyurethane modified asphalt prepared in Example 13 was added and stirred well (stirring time: 90 s). Ore powder was added to the resulting mixture material, and stirred well for 90 s. The resulting mixture material was compaction molded at 140° C. for 75 times. The molded specimens were cured in an oven at 100° C. for 24 h, and cured at room temperature for 2 days. The specimens were tested to have a Marshall stability at 60° C. of 11.66 and a flow value of 4.04.

### Example 18 Preparation of Modified Asphalt Mixture

100 parts of AC-13 graded aggregates were added to a mixing pot at 165° C. and mixed well, then 4.8 parts of the castor oil-based polyurethane modified asphalt prepared in Example 14 was added and stirred well (stirring time: 180 s). Ore powder was added to the resulting mixture material, and stirred well for 180 s. The resulting mixture material was compaction molded at 145° C. for 75 times. The molded specimens were cured in an oven at 100° C. for 24 h, and cured at room temperature for 3 days. The specimens were tested to have a Marshall stability at 60° C. of 10.85 and a flow value of 3.69.

### Example 19 Preparation of Modified Asphalt Mixture

100 parts of AC-13 graded aggregates were added to a mixing pot at 170° C. and mixed well, then 4.8 parts of the castor oil-based polyurethane modified asphalt prepared in Example 16 was added and stirred well (stirring time: 180 s). Ore powder was added to the resulting mixture material, and stirred well for 180 s. The resulting mixture material was compaction molded at 150° C. for 75 times. The molded specimens were cured in an oven at 100° C. for 24 h, and cured at room temperature for 4 days. The specimens were tested to have a Marshall stability at 60° C. of 10.73 and a flow value of 3.10.

### Property Characterization of Examples 17-19

Conventional Marshall property test was performed on the modified asphalt mixture material prepared from the vegetable oil-based polyurethane of the Examples 5-7 according to Standard Test Methods of Bitumen and Bituminous Mixtures for Highway Engineering (JTG E20-2011).

TABLE 5
Test on Marshall property of the vegetable oil-
based polyurethane modified asphalt mixture

| | | Flow |
|---|---|---|
| Example | Marshall stability(KN) | value(mm) |
| Example 17 | 11.66 | 4.04 |
| Example 18 | 10.85 | 3.69 |
| Example 19 | 10.73 | 3.10 |

### Example 20

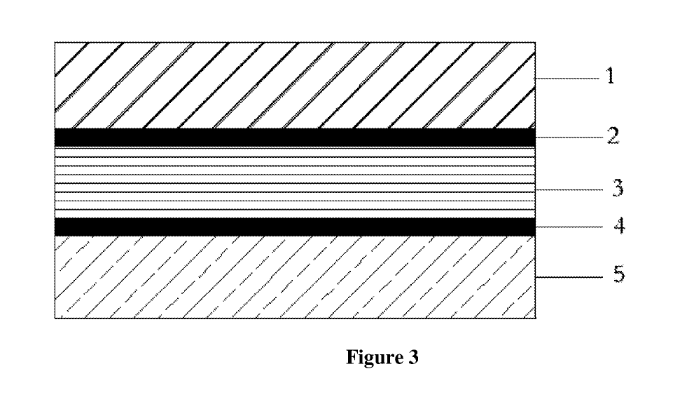

As shown in FIG. 3, this example provided a polyurethane modified asphalt pavement structure, which comprises a roadbed, a base layer and a surface layer sequentially arranged from the bottom to the top. Preferably, in this example, the layer number of the surface layer was three, and adhesive layers were respectively arranged between the surface layers, specifically, the lower surface layer 5, the second adhesive layer 4, the middle surface layer 3, the first adhesive layer 2 and the upper surface layer 1 were sequentially paved from the bottom up. At least one of the upper surface layer 1, the middle surface layer 3 and the lower surface layer 5 was made of polyurethane-modified asphalt mixture material having good high- and low-temperature performances. Compared with ordinary asphalt pavement, the mixture material has higher hardness, better elasticity and higher wear resistance, and can effectively improve the rutting resistance and low temperature crack resistance of the pavement, thereby playing a role of protecting pavement, helping to prolong service life of the pavement and improving traffic safety. In addition, using polyurethane modified asphalt mixture material reduces the post-maintenance cost and is cost-effective.

Specifically, the type of the polyurethane modified asphalt mixture material is AC or ATB or SMA or AM or ATPB or OGFC or other asphalt mixture material that satisfies Technical Specification for Construction of Highway Asphalt Pavements. In this example, the surface layer can be selected from conventional gradation type such as AC or ATB or SMA or AM or ATPB or OGFC, but should satisfy the requirements of Specifications for Design of Highway Asphalt Pavement.

Furthermore, the layer number of the surface layer is single or double or triple. According to the budget and specific implementation conditions, an appropriate surface layer is chosen. If a single-layer structure is adopted, then polyurethane modified asphalt mixture material is used; if a double- or three-layer structure is used, at least one layer adopts polyurethane modified asphalt mixture material, and the other layer(s) that do not use polyurethane modified asphalt mixture material can use matrix asphalt or modified asphalt according to the specific circumstances.

Specifically, an adhesive layer is provided between the plurality of surface layers, and the adhesive layer is made of emulsified asphalt or modified emulsified asphalt or modified asphalt or petroleum asphalt or other adhesive materials meeting the Technical Specification for Construction of Highway Asphalt Pavements, and the spreading amount of the adhesive layer is 0.3 L/m²-2.5 L/m². In this Example, the first adhesive layer 2 can play the function of adhesion between the upper surface layer 1 and the middle surface layer 3, and the second adhesive layer 4 serves as a transition layer between the middle surface layer 3 and the lower surface layer 5, and is very important for the surface layer using polyurethane modified asphalt to give full property. The second adhesive layer 4 using asphalt material has waterproof, moisture-proof and anticorrosion effect, and can effectively improve the usability of pavement structure. In comprehensive consideration of the adhesive effect and economy, the spreading amounts of the first adhesive layer 2 and the second adhesive layer 4 are controlled between 0.3 L/m² and 2.5 L/m².

Wherein, layer-penetration oil is sprayed between the base layer and the surface layer, and further, a sealing layer may be further disposed between the layer-penetration oil and the surface layer. By spraying layer-penetration oil on the base layer, a thin layer is formed with a certain depth on the surface of the base layer, to prevent water permeation of the base layer, consolidate the surface of the base layer, and allow for good connection between the base layer and the asphalt surface layer and other beneficial effects.

Wherein the base layer is a flexible base layer, a semi-rigid base layer or a rigid base layer. In this example, the base layer was a cement stabilized macadam layer which belongs to a semi-rigid base layer. The lower surface layer 5 was paved on the base layer. The purpose of using the matrix asphalt or modified asphalt is to ensure that the cement stabilized macadam base layer has certain flexibility, so as to solve the problems that the cement stabilized macadam base layer is liable to cracking caused by dry shrinkage and thermal shrinkage. Particularly, the lower surface layer adopts the polyurethane modified asphalt of the present invention, and has excellent pavement performance.

Preferably, in this example, the surface layer with single-layer structure has a thickness in the range from 10 mm to 80 mm; the surface layer with double-layer or three-layer structure has a total thickness in the range from 60 mm to 300 mm, which meets the usage requirement, ensures good molding effect, helps to avoid waste of resources, saves money, and provide good economy.

### Example 21

This example provided a polyurethane modified asphalt pavement structure, which comprises a roadbed, a base layer and a surface layer sequentially arranged from bottom up. Preferably, in this example, the layer number the surface layer was double, and an adhesive layer was provided between the two surface layers. The other technical solutions were identical to the technical solutions of Example 20. To avoid repeated description, the details are not described here.

### Example 22

This example provided a polyurethane modified asphalt pavement structure, which comprises a roadbed, a base layer and a surface layer sequentially arranged from bottom up. Preferably, in this example, the layer number the surface layer was single, and no adhesive layer was provided. The other technical solutions were identical to the technical solutions of Example 20. To avoid repeated description, the details are not described here.

In particular, in this example, the layer number of the surface layer was at least one. The above examples only exemplify the preferred solutions of the surface layer with single-layer or double-layer or three-layer structure, but it is not limited to three layers. When the surface layer has a structure of four or more layers, and the adhesive layer(s) is provided accordingly with reference to Example 20.

### INDUSTRIAL APPLICABILITY

The polyurethane provided by the invention is synthesized under mild conditions, and can occur secondary reaction with air and active hydrogen components in asphalt during the curing process to further enhance the strength of the mixture, and the standard Marshall stability at 60° C. of the polyurethane-modified asphalt meets the requirements of petroleum asphalt specification, and can prolong the service life of asphalt pavement. The modified asphalt mixture using the polyurethane of the present invention has low mixing temperature, and short curing time; Marshall strength of the mixture material in a short period of time is high at a relatively low dosage, and the intensity increases with the increase of temperature and the extension of curing time.

The surface layer of the polyurethane modified asphalt pavement structure provided by the invention is made of polyurethane modified asphalt mixture material, which has the advantages of fatigue resistance, high hardness, good elasticity, strong abrasion resistance and the like, can effectively improve the rutting resistance, low temperature resistance, and water and crack resistance of the pavement, thereby avoiding pavement cracking, playing the role of protecting pavement, prolonging the service life of the road, and improving safety of the pavement. In addition, the polyurethane modified asphalt pavement structure has low post-maintenance cost, which is conducive to economy.

1. A method for preparing a polyurethane-modified asphalt, comprising:
(a) adding a polymerization inhibitor, a catalyst, and an isocyanate component into a reactor;
(b) adding a polyol to the reactor while stirring the resulted mixture at room temperature under nitrogen;
(c) heating the mixture obtained from (b) to a temperature of 50-80° C., and holding the temperature to react for 0.5 to 6 hours to obtain a polyurethane prepolymer; and
(d) continuously reacting the polyurethane prepolymer obtained from (c) in an asphalt or asphalt mixture material system under high temperature to produce the polyurethane-modified asphalt,
wherein,
the polymerization inhibitor comprises one or two selected from the group consisting of p-benzenesulfonate, benzoyl chloride, phosphoric acid, and dimethyl sulfate;
the isocyanate component comprises one or two selected from the group consisting of liquefied MDI, TDI dimer, TDI trimer, TDI-TMP adduct, HDI dimer, HDI trimer, and IPDI trimer; and
the polyol comprises one or more selected from the group consisting of castor oil, dehydrated castor oil, adipic acid-based polyester diol, polyolefin polyol, polyoxypropylene glycol, polyoxypropylene-oxyethylene copolyether triol, trimethylolpropane, vegetable oil polyol, and polytetrahydrofuran polyol.

2. The method of claim 1, wherein
the reaction between the isocyanate component and the polyol has an R index ranging from 1.4 to 2.0, and
the polymerization inhibitor is added in an amount ranging from 0.01% to 3% by weight, calculated with respect to the total mass of the isocyanate component and the polyol.

3. The method of claim 1, wherein
the catalyst inhibitor is added in amount ranging from 0.5% to 1% by weight, calculated with respect to the total mass of the isocyanate component and the polyol, and
the catalyst is selected from the group consisting of an organotin-based catalyst, a tertiary amine-based catalyst, and a quaternary ammonium salt compound.

4. The method of claim 1, wherein
the polyol is selected from the group consisting of polyester polyols, polyether polyols, vegetable oil polyols, and composite polyols of any two thereof;
the polyester polyol is selected from the group consisting of adipic acid-based polyester diols, polyolefin polyols, and polyoxypropylene glycol; and
the polyether polyol is one or more selected from the group consisting of polyoxypropylene-oxyethylene copolyether triol, trimethylolpropane, vegetable oil polyol, and polytetrahydrofuran polyol.

5. The method of claim 4, wherein
the mass ratio of the polyester polyol to the polyether polyol in the composite polyol is (2:1) to (1:1); and
the polyester polyol is added first to the reactor, heated to 50-80° C., and held at the temperature for 0.5 to 1.5 hours, then the polyether polyol is dropwise added to the reaction system, and the resulting mixture is held at the temperature to react for 1.5 to 3 hours.

6. The method of claim 1, wherein the polyol is obtained by dehydrating in a vacuum box at 110-120° C. under a pressure of 0.05 to 0.2 MPa for 2 to 3 hours; and a solvent is added to the reactor in an amount ranging from 10% to 50%, calculated with respect to the total mass of the mixture resulting from (b), wherein the solvent is one or two selected from the group consisting of acetone, ethyl acetate, and butyl acetate.

7. The method of claim 1, wherein a component A and a component B are stirred and mixed in a mass ratio of 1:0.8-1.2 for use, wherein
the component A is the reaction system obtained after the reaction is conducted at 50-80° C. for 0.5 to 6 hours, and the component B is obtained from 1 part by mass of catalyst, 3 parts by mass of chain extender, 1 part by mass of plasticizer, and 1 part by mass of anti-foaming agent; and
the catalyst is an organotin-based catalyst or a tertiary amine-based catalyst; the chain extender is selected from the group consisting of trimethylolpropane, 1,4-butanediol, 1,2-propanediol, polyethylene glycol 200, triethanolamine and other small molecule alcohols and amines; the plasticizer is dioctyl phthalate or dibutyl phthalate; and the anti-foaming agent is calcium oxide.

8. A polyurethane modified asphalt, prepared by the method of claim 1, wherein the polyurethane prepolymer accounts for 10% to 40% by weight of the polyurethane modified asphalt.

9. The method of claim 1, wherein (d) comprises mixing the polyurethane prepolymer with the asphalt or asphalt mixture material system, and quickly stirring the resulted mixture at 120-130° C. for 10 to 30 min to obtain the polyurethane modified asphalt.

10. The polyurethane-modified asphalt of claim 8, comprising 10-40 parts of polyurethane prepolymer, 90-50 parts of asphalt and 0-5 parts of one or more additive; wherein the one or more additive is selected from the group consisting of a catalyst, a chain extender, a plasticizer, and an anti-foaming agent.

11. The polyurethane-modified asphalt of claim 10, wherein
the catalyst is an organotin-based catalyst or a tertiary amine catalyst, and accounts for 1% to 3% of the total amount of the polyurethane;
the chain extender is selected from the group consisting of trimethylolpropane, 1,4-butanediol, 1,2-propanediol, polyethylene glycol 200, triethanolamine and other small molecule alcohols and amines, and accounts for 2% to 4% of the total amount of the polyurethane;
the plasticizer is dioctyl phthalate or dibutyl phthalate, and accounts for 2% to 5% of the total amount of the vegetable oil-based polyurethane; and
the anti-foaming agent is calcium oxide, and accounts for 0 to 1% of the total amount of polyurethane.

12. The method of claim 1, wherein (d) comprises baking the asphalt or asphalt mixture material system at 135° C. for 3 hours and then slowly adding the polyurethane prepolymer at 110-120° C. while shearing.

13. A mixture material comprising the polyurethane-modified asphalt of claim 8 and aggregates.

14. A method for preparing the mixture material of claim 13, wherein the method comprises a method selected from the group consisting of the following methods:
method I: baking aggregates at a temperature of 120-130° C. for 3 to 6 hours, adding 100 parts of the baked aggregates to a mixing pot, adding 2-8 parts of polyurethane prepolymer modified asphalt, mixing well at 110-150° C., adding ore powder, and mixing for 80 to 150 s; or
method II: pre-heating 100 parts of aggregates to 130-165° C., adding fine aggregates and coarse aggregates to a mixing pot pre-heated to 130-165° C. and mixing the aggregates well; adding 4-6 parts of the claim 1, one or more additive, and asphalt to the aggregates, and mixing for 90 to 180 s; adding ore powder, continuously mixing for 90 to 180 s, and then compaction molding the resulted mixture at 135-140° C. to form a molded specimen; curing the molded specimen in an oven at 100° C. for 20 to 30 hours, and then at room temperature for 2 to 4 days; and
method III: pre-heating aggregates to 140-170° C., adding fine aggregates and coarse aggregates to a mixing pot pre-heated to 140-170° C. and mixing the aggregates well; adding the polyurethane modified asphalt of claim 8 to the aggregates, and mixing for 90 to 180 s; adding ore powder to the resulted mixture material, continuously mixing for 90 to 180 s; compaction molding for 70 to 80 times at 140-150° C. to form a molded specimen; and curing the molded specimen in an oven at 100° C. for 24 hours, and then at room temperature for 2 to 4 days.

15. The mixture material of claim 13, wherein the fine aggregates have a nominal grain size of 0.075 mm<δ<4.75 mm, the coarse aggregates have a nominal grain size of 4.75 mm≤δ, the ore powder is obtained from limestone by grinding, and has a nominal grain size of δ≤0.075 mm; the gradation of the aggregates meets the requirements of the Technical Specification for Construction of Highway Asphalt Pavements;
the one or more additive is selected from the group consisting of a catalyst, a chain extender, a plasticizer, and an anti-foaming agent; the catalyst is an organotin-based catalyst or a tertiary amine catalyst, and accounts for 1% to 3% of the total amount of the polyurethane prepolymer; the chain extender is selected from the group consisting of trimethylolpropane (TMP), 1,4-butanediol, 1,2-propanediol, polyethylene glycol 200, triethanolamine and other small molecule alcohols and amines, and accounts for 2% to 4% of the total amount of the vegetable oil-based polyurethane prepolymer; the plasticizer is dioctyl phthalate or dibutyl phthalate, and accounts for 2% to 5% of the total amount of the vegetable oil-based polyurethane prepolymer; and the anti-foaming agent is calcium oxide, and accounts for 0 to 1% of the total amount of the vegetable oil-based polyurethane prepolymer.

16. A method for paving, reinforcing and repairing a surface selected from the group consisting of highways, expressways, municipal roads, pavements for very heavy traffic, hot area pavements, square pavements and airport pavements, wherein the method comprises applying a mixture material according to claim 13 to the surface.

17. A pavement structure using polyurethane modified asphalt, comprising the following components arranged sequentially from bottom to top: a roadbed, a base layer, and a surface layer, wherein the surface layer is made of the mixture material according to claim 13, and the layer number of the surface layer is at least one.

18. The pavement structure of claim 17, wherein the layer number of the surface layers is two or more, and wherein an adhesive layer is provided between every two surface layers, and the adhesive layer is made of emulsified asphalt, modified emulsified asphalt, modified asphalt, petroleum asphalt or other adhesive materials meeting the Technical Specification for Construction of Highway Asphalt Pavements, and the spreading amount of the adhesive layer is 0.3 L/m² to 2.5 L/m².

19. The pavement structure of claim 17, further comprising a layer-penetration oil sprayed between the base layer and the surface layer, wherein the base layer is a flexible base layer, a semi-rigid base layer, or a rigid base layer.

20. The pavement structure of claim 19, further comprising a sealing layer provided between the layer-penetration oil and the surface layer.
